(19) United States
(12) Patent Application Publication
(10) Pub. No.: US 2013/0144702 A1
(43) Pub. Date: Jun. 6, 2013

(54) Integrated Payment and Reward Transactions

(71) Applicants: Catherine M. Tabor, Atlanta, GA (US); Ken R. Powell, Watkinsville, GA (US); John W. Daniel, Bogart, GA (US); Terry Bruehl, Atlanta, GA (US)

(72) Inventors: Catherine M. Tabor, Atlanta, GA (US); Ken R. Powell, Watkinsville, GA (US); John W. Daniel, Bogart, GA (US); Terry Bruehl, Atlanta, GA (US)

(73) Assignee: SPARKFLY LLC, Atlanta, GA (US)

(21) Appl. No.: 13/308,940

(22) Filed: Dec. 1, 2011

(51) Int. Cl. G06Q 30/02

(52) U.S. Cl. 705/14.26

(57) ABSTRACT

Systems and methods for providing mobile promotional transactions that are combined with the payment processes to provide integrated solutions for a single transaction event at a transaction device (POS device). According to one embodiment, a method may be provided to operate and receive a request to process a transaction and a promotional code for a reward in a single transaction. In some aspects, the promotional code may be received by a mobile device based at least in part on an event outcome indicator. Additionally, the method may be operable to determine or receive that the promotional code is valid and determine or receive a value associated with the promotional code. Further, the method also be operable to apply a discount to the transaction value, in some examples, based at least in part on the value associated with the promotional code.

### BACKGROUND

In both traditional brick-and-mortar stores and e-commerce sites, merchants often provide promotions to incentivize customers to purchase goods and/or services. For instance, a merchant may provide a coupon to a potential customer in the hopes that the potential customer will eventually make a purchase. If the customer is pleased with the purchase they may return for subsequent purchases. However, in many instances the customer may be burdened with inconvenient coupon redemption solutions. As such, finding ways to redeem promotional content continues to be a priority.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example architecture for providing integrated payment and reward transactions associated with a merchant and a transaction device, according to an example implementation.

FIG. 2 illustrates an example architecture for communication between a third-party or merchant transaction device (e.g., a point of sale (POS) device) and a service provider computer for providing games, challenges, promotional content associated with the merchant to a mobile device, according to an example implementation.

FIGS. 3 and 4 illustrate memory storage devices for storing one or more promotional codes and promotional information, respectively, for use in some examples, with the architectures of FIG. 1 and/or 2, according to an example implementation.

FIG. 5 illustrates an example flow diagram of an embodiment of a process for providing integrated payment and reward transactions associated with a merchant and a transaction device, according to an example implementation.

### DETAILED DESCRIPTION

### Overview

Embodiments of the present disclosure are directed to, among other things, providing integrated payment and reward transactions associated with a merchant and a transaction device, including near-field communication (NFC) devices. As an overview, a transaction device may be a cash register, a point of sale (POS) device, a computer terminal, an automated teller machine (ATM), a tablet personal computer (PC), a personal digital assistant (PDA), or any other type of device that is capable or configurable to process a transaction. A transaction may involve an exchange of goods or services for money, other goods or services, or any other type of valuable consideration.

In some aspects, content may be provided to a mobile device. The mobile device may then provide the content to a consumer via a display or other user interface. Upon satisfying a condition related to the content, a promotional code may be provided to the consumer. In some aspects, this promotional code may be utilized as a discount at a merchant location. For example, the promotional code may indicate to the merchant that the consumer has earned, won, or otherwise acquired a discount on a particular item or items and/or service (or services), or that the consumer has earned, won, or otherwise acquired a discount on the total value of goods and/or services.

By way of example only, content may be a game, a challenge, a question, a promotion, a coupon, a coupon code, a unique identifier, a product, a service, a sellable unit, a user profile, location information, or anything else that can be transmitted to a mobile device or other computing device. An on-line (or brick-and-mortar) merchant or a third-party vendor (e.g., a consumer goods manufacturer or other consumer packaged goods (CPG) provider) may provide coupons, games, and/or challenges for mobile devices and their users (i.e., the consumer). One or more games and/or challenges may then be selected for presentation to appropriate users based on several factors. For example, appropriate games and/or challenges may be selected for a particular consumer based on the location of the consumer's mobile device, the location of a merchant, past purchasing behavior of the consumer, and/or demographic information associated with the consumer.

In some examples, once a condition is satisfied regarding the game and/or challenge (e.g., a challenge question is answered correctly or a game is won), promotional content may be provided to the consumer. In some aspects, promotional content may include a coupon or other discount for use at a merchant's or third-party vendor's establishment or website. Additionally, in some aspects, the promotional content may include a unique identifier (e.g., a promotional code) for indicating to the merchant that the consumer earned a coupon or discount. Similarly, or alternatively, in some examples, promotional content may be selected for presentation to a consumer based on the location information and other user information (e.g., purchase history information and/or demographic information) without first providing the game and/or challenge.

In some instances, a service provider may receive, store, and/or manage games, challenges, and/or promotional content provided by merchants and/or third-party vendors. By way of example only, a merchant may include a restaurant, a convenience store, a supermarket, a retail store, a doctor or other service provider, an on-line store, a mechanic, a wholesaler, or any other type of business that provides goods and/or services to consumers. Similarly, a third-party vendor may include any of the above types of merchants and/or providers of products and/or services that are sold at, but are not necessarily directly associated with, the merchant. For example, a provider of a brand of soda sold exclusively or otherwise at a restaurant may be a third-party vendor.

In some examples, the service provider may receive location and/or user information associated with a mobile device. Location information may include global positioning service (GPS) information transmitted from the mobile device, location information entered by a user of the mobile device, and/or location information determined based on a location of a cellular tower or Wi-Fi™ device through which the mobile device is communicating. Further, user information associated with the mobile device may include purchase behavior information (e.g., products and/or services, types of products and/or services, amounts of products and/or services, values of products and/or services, and/or frequency of purchase of products and/or services purchased by a consumer using the mobile device or at least associated with the mobile device) and/or demographic information (e.g., a name, address, average income, sex, and/or race associated with a consumer).

Additionally, the service provider may receive games and/or challenges intended for particular mobile devices (e.g., devices belonging to members of certain demographics and/or groups). Alternatively, or in addition, the games and/or challenges may be intended for devices that are located in certain geographic locations. For example, a retail store (or chain of retail stores) may provide a game and/or challenge to the service provider that is intended for mobile devices within a predefined distance from the physical location of the retail store (or one of the chain of retail stores). In this way, particular mobile devices may be targeted when the service provider receives information indicating that a mobile device is within the range (e.g., within a mile of the location, within five miles of the location, within the same zip code, within the same city or county as the location, or traveling towards the location from any distance). Further, in some examples, particular mobile devices may be targeted based on a combination of the physical location of the mobile device and the demographic and/or user information.

In some instances, a consumer may control a mobile device and activate an application or other software program for receiving promotions, playing games, completing challenges, and/or processing transactions with a transaction device (e.g., a POS device). The application or software program may display the promotions, games, and/or challenges that were received from the service provider. In some examples, the consumer may be presented with one or more promotions, games, and/or challenges provided by the service provider. For example, the service provider may determine an appropriate list or set of promotions, games, and/or challenges for the consumer based on the physical location of the consumer or the mobile device of the consumer or based on the user information associated with the consumer or the mobile device of the consumer (such as purchase behavior history and/or demographic information). This appropriate list, set, or other grouping of determined promotions, games, and/or challenges may be transmitted to the mobile device, and/or retrieved from memory of the mobile device in whole or in part, for presentation. Alternatively, or in addition, the service provider may transmit information related to one or more merchants that the service provider determines is appropriate based on the location information, the user information, or a combination. In this example, the consumer may select a merchant, rather than a game and/or challenge, and the game and/or challenge associated with the selected merchant may then be presented.

In some aspects, games and/or challenges may be interactive and/or graphical video-type games, such as but not limited to first-person shooter games, adventure games, role-playing games, and the like. However, games and/or challenges may also include trivia questions, word scrambles, scavenger hunts, and the like. In one non-limiting example, a game and/or challenge may request a consumer to identify the third wine on a wine list of a particular restaurant or a manager's name. In another non-limiting example, a game and/or challenge may require the consumer to frequent a location or locations or purchase items and services from a number of different merchants in order to complete the game and/or challenge. Other examples may include collecting items from merchant's stores or answering historical trivia questions about the merchant, a third-party vendor, or other entities, locations, or events.

In certain examples, once a consumer has successfully completed a game and/or challenge, the mobile device or merchant (e.g., based on batch or real-time delivery of consumer information/ID) may transmit an outcome event indication or response to the service provider. The service provider may be configured to determine whether the game and/or challenge was completed correctly (or at least to the satisfaction of the merchant and/or third-party vendor), whether the mobile device is registered with the service provider, and/or whether the game and/or challenge is still valid. In some instances, the service provider may provide a unique identifier or promotional code to the mobile device. This promotional code may be presented to the merchant to indicate that the consumer has earned a promotion, coupon, and/or discount. Upon verification of the promotional code, either locally or with the service provider, the merchant may then discount the price of a specific item or group of items or the total sales price for items purchased and/or services provided for the consumer.

In some examples, a point of sale (POS) device located at the merchant may be integrated with software for performing the disclosed features and may be communicatively coupled to a computer of the service provider such that these features may be performed automatically, seamlessly, and/or in real-time. The POS system may receive the unique identifier (or promotional code) from the merchant or consumer with a card scan or swipe, barcode scan from the mobile device display, keypad entry, touch screen for input, mouse input, the transmission of a signal from the mobile device via NFC, or capturing other biometric input from the consumer such as fingerprint, voice, eye, or facial features. As such, the POS device may receive the unique identifier, promotional code, and/or reward, verify the promotional code with the service provider, against identifiers/promotional codes stored locally, and/or with the mobile device, and then provide the discount to a pending transaction in real-time or near real-time. Additionally, in some examples, the POS device or the merchant may record or otherwise maintain a list of consumers that have successfully completed the challenge and/or game. In this example, the POS device or the merchant may periodically (or in real-time) transmit unique identifiers and/or the list of consumers that have completed tasks to the service provider.

Additionally, in some instances, the service provider may receive and record an indication that a consumer and/or mobile device has redeemed a promotion with a particular merchant and may allow the consumer to interact with (e.g., by “unlocking”) the next game and/or challenge associated with that particular merchant. In this way, the consumer may be incentivized to return to that particular merchant creating repeat business for the merchant and/or third-party vendor. As used herein, “unlocking” refers to providing promotions, games, and/or challenges to users that were previously “locked” or otherwise unavailable. That is, a “locked” promotion, game, or challenge may be visible to a user in that it may be selectable or viewable; however, the user may not be able to participate and/or complete the game and/or challenge. In some aspects, the “locked” games and/or challenges provide greater rewards than the “unlocked” ones, thus encouraging users to complete games and/or challenges to further “unlock” additional games and/or challenges. This may also promote repeat customers.

For example, upon selecting a merchant for the first time, a first game and/or challenge may be automatically “unlocked” such that the user may be able to select, interact with, and/or play/complete the game and/or challenge. In some instances, this may be considered the first level. As games are completed, and new games are “unlocked,” the user may progress to higher levels. In some aspects, advancing to the next level may include the possibility of increased rewards. That is, in some examples, the next level may provide a greater discount or a more valuable reward (or at least the opportunity for a greater discount or more valuable reward) than the last level.

Additionally, social networking may be utilized to allow users to interact with other social network members to promote the service provider and/or the promotions platform. For example, promoting the promotions platform and/or recruiting new members via a social networking site may lead to increased discounts for the user who initiates the promotion and/or the recruitment.

In some examples, the mobile device may be configured with a mobile wallet for performing payment transactions and/or a rewards wallet for managing and/or storing rewards and/or coupons earned, won, collected, or otherwise acquired by the consumer. In some aspects, a mobile payments wallet may be linked to a rewards wallet or may be a single mobile wallet that provides functionality for payment from the mobile device, from a financial institution, or from a payment processor for goods and/or services provided by the merchant. Additionally, in some aspects, a rewards wallet may be configured to store rewards, promotional codes, and/or unique identifiers that identify rewards. The rewards wallet may also be configured to manage the rewards, promotional codes, and/or unique identifiers stored therein. As such, the rewards wallet may be utilized, in some instances, to verify and/or validate that a promotional code, a unique identifier, and/or a reward is valid.

Further, in some examples, the POS device may provide the discount to a pending transaction in real-time or near real-time, as noted above. For example, the POS device may receive the unique identifier, the promotional code, or an indication of the reward or discount, deduct the discount from the transaction value (e.g., the value of one or more goods and/or services provided by the merchant) at an item level or based on the total value of a combination of goods and/or services, and consummate the transaction by sending the discounted total to the mobile device and receiving payment. In some examples, payment may be received from the mobile device, via the mobile wallet, from a financial institution such as, but not limited to, a bank, a credit card company, etc., or from a payment processor that facilitates payments for financial institutions.

The following discussion begins with a section entitled “Illustrative Architecture,” which describes a non-limiting environment in which a service provider may interact with one or more mobile devices, one or more merchants, and/or one or more third-party vendors for providing games, challenges, and/or promotions to users and/or mobile devices. The discussion then concludes with a section entitled “Illustrative Processes” and a brief conclusion.

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

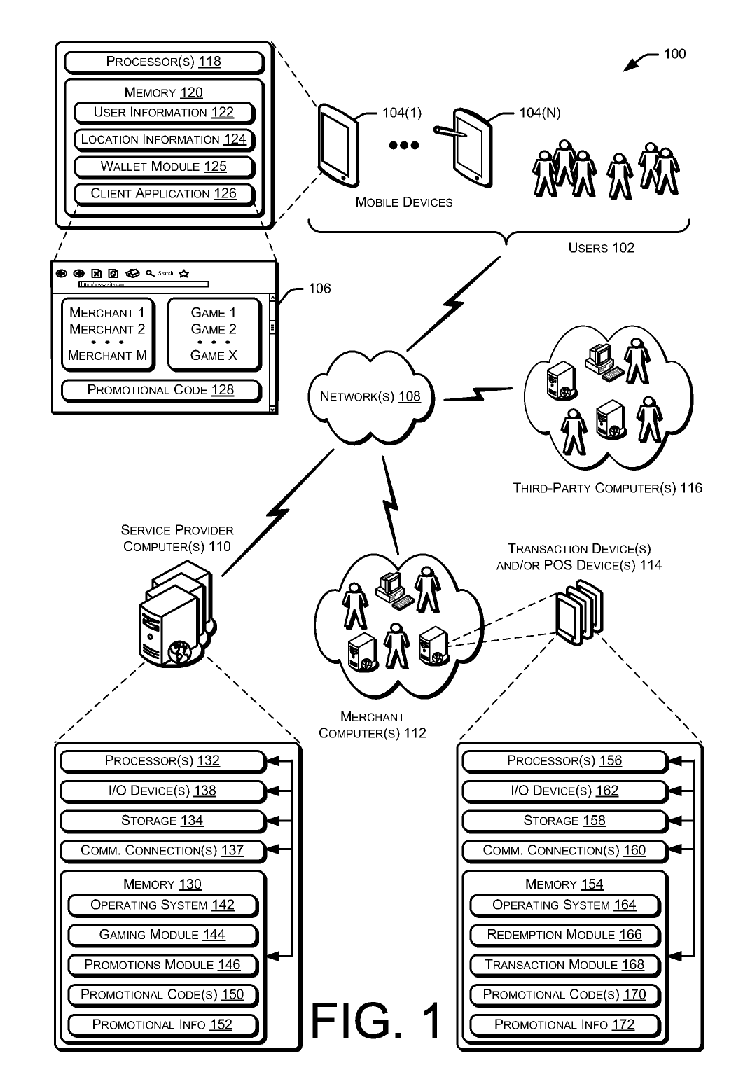

FIG. 1 depicts an illustrative architecture 100 in which techniques for providing integrated payment and reward transactions associated with a merchant and a transaction device may be implemented. In architecture 100, one or more users 102 may utilize mobile computing devices (or NFC devices) 104(1), . . . , 104(N) to access a client application interface (or website) 106 that may be provided by, created by, or otherwise associated with a service provider via one or more networks 108. In some instances, the mobile computing devices (collectively 104) may be configured to present or otherwise display the client application interface 106 to one or more users 102. The networks 108 may include any one or a combination of multiple different types of networks, such as cable networks, the Internet, wireless networks, and other private and/or public networks. While the illustrated example represents users 102 accessing the client application interface 106 over the networks 108, the described techniques may equally apply in instances where the users 102 interact with a service provider via a personal computer, over the phone, via a kiosk, or in any other manner. It is also noted that the described techniques may apply in other client/server arrangements (e.g., set top boxes, etc.), as well as in non-client/server arrangements (e.g., locally-stored software applications, etc.).

In some aspects, and as described briefly above, the client application interface 106 may allow the users 102 to access, receive from, transmit to, or otherwise interact with a service provider via one or more service provider computers 110. In some examples, the client application interface 106 may also allow users to receive games, challenges, and/or promotions from the service provider computers 110 over the networks 108. Through the client application interface 106, the users 102 may play games, complete challenges, answer trivia questions, and/or receive information.

The architecture 100 may also include one or more merchant computing devices 112. The merchant computing devices 112 may be any type of computing devices, such as but not limited to, mobile, desktop, and/or cloud computing devices, such as servers. In some examples, the merchant computers 112 may be in communication with the service provider computers 110 via the networks 108, or via other network connections. The merchant computers 112 may include one or more servers, perhaps arranged in a cluster, as a server farm, or as individual servers not associated with one another. These servers may be configured to host a website viewable via the client application interface 106 or any other Web browser accessible by a user 102, such as but not limited to one or more of the mobile devices 104. Additionally, in some aspects, the merchant computers 112 may be configured to create and/or provide games and/or challenges for the mobile devices 104.

In some embodiments, a merchant computer 112 may be coupled with, or integrated within, one or more transaction devices (or POS devices) 114 for completing transactions with customers or users 102. The one or more POS devices 114 may be configured to process purchase transactions of a user 102 either at a brick-and-mortar location or accessible via the Internet and may include, but are not limited to, handheld POS devices, desktop-style, kiosk-style, and/or register-style POS devices. In some aspects, the features of the service provider computers 110 may be integrated within the POS device 114 such that the POS device 114 may be able to read, identify, or otherwise receive input regarding a completed challenge and/or a game won on a mobile device 104. Additionally, the one or more POS devices 114 may receive payment from the mobile devices 104 to consummate, process, or otherwise complete transactions with the user 102. Further, the POS devices 114 may be directly coupled to one or more servers of the merchant computers 112 or may be coupled, through a translational layer, to a load balancer.

The architecture 100 may also include one or more third-party computing devices 116. The third-party computing devices 116 may also be any type of computing devices, such as but not limited to, mobile, desktop, and/or cloud computing devices, such as servers. In some examples, the third-party computers 116 may be in communication with the service provider computers 110 via the networks 108, or via other network connections. The third-party computers 116 may include one or more servers, perhaps arranged in a cluster, as a server farm, or as individual servers not associated with one another. These servers may be configured to host a website viewable via the client application interface 106 or any other Web browser accessible by a user 102, such as but not limited to one or more of the mobile devices 104. Additionally, in some aspects, the third-party computers 116 may be configured to create and/or provide games and/or challenges for the mobile devices 104.

In some aspects, the third-party computers 116 may be configured to receive, store, manage, distribute, analyze, and/or determine user information associated with users 102. For example, a third-party computer 116 may be configured to receive purchase history information associated with a user 102 or a mobile device 104. Additionally, a different (or the same) third-party computer 116 may be configured to receive demographic information associated with a user 102 and/or a mobile device 104. In some examples, a user 102 may be able to update or otherwise change their own demographic information received by, and/or stored at, the third-party computers 116. In some instances, the third-party computers 116 may create categories, levels, or other groupings of user 102 based on the received user information. The service provider computers 110 may then select appropriate promotions, games, and/or challenges to be sent to the mobile devices 104 based on this information.

The mobile devices 104 may be any type of computing devices, including but not limited to mobile phones, personal digital assistants (PDAs), tablets personal computers (PCs), game consoles, set-top boxes, and the like. In some instances and as illustrated, each user computing device 104 may be equipped with one or more processors 118 and memory 120 to store applications and data, such as user information 122, location information 124, a wallet module 125, and a client application 126 that displays the client application interface 106 and/or enables access to the website 106 stored on the service provider computers 110 or elsewhere.

In some instances, the wallet module 125 may configured as a mobile wallet application and/or a rewards wallet application. By way of example only, a mobile wallet application may include functionality for storing payment information such as, but not limited to, financial institution routing numbers, credit card numbers, debit card numbers, closed and/or open loop account numbers, decoupled debit payment numbers, or any other payment numbers associated with a payment instrument. When prompted, by a user 102 or a merchant computer 112, the mobile wallet application may provide the payment information to effectuate payment of a value for goods and/or services. In this way, the wallet module 125 may be configured to facilitate the processing of transactions with merchant computers 112 and/or associated transaction devices 114.

Additionally, and also by way of example only, a reward wallet application may include functionality for storing and/or managing rewards and/or promotions of a user 102. For example, the rewards wallet may allow a user to “clip” or otherwise collect coupons, rewards, and/or discounts found on websites or elsewhere. Additionally, the rewards wallet may allow a user to store promotional codes 128 earned or otherwise received based on winning or completing a game and/or a challenge. The rewards wallet may also manage the coupons, rewards, or promotions stored therein, such that the coupons, rewards, or promotions may be marked as “used,” “expired,” or otherwise no longer available for redemption.

Further, the wallet module 125 may provide preference options to the user 102, such that the user 102 may define one or more “rules” regarding how and/or when the promotions, coupons, and/or rewards are to be applied. For example, the user 102 may elect to always apply promotional discounts when available for any participating merchant without additional interaction from the user 102. By way of example only, if a user 102 purchased a meal and the meal was eligible for a promotional discount (assuming the user 102 had previously won and/or received a discount for this meal or a portion of the meal), the discount may be automatically applied at the time of payment.

The user information 122 may be personal information associated with the user 102 of the computing device 104. For example, the user information 122 may include general demographic information such as name, age, address, and salary range and/or enhanced demographic information such as sex, race, telephone number, height, weight, etc. of the user 102. This user information 122 may be provided by the user 102 or may be aggregated by the service provider computers 110, the third-party computers 116, or some other service, and transmitted to the mobile device 104. The location information 124 may be based on the physical location of the mobile device 104. This location information 124 may be provided by, or otherwise determined by, GPS, triangulation, Internet protocol (IP) address, router location, or any other methods for determining a location of a mobile device 104.

Additionally, the user information 122 may include purchase behavior information based on purchased items or services, amounts of purchased items or services, dollar amounts spent on purchased items or services, etc. For example, a purchase history may include information associated with some or all products purchased by a consumer using a mobile device or associated with the mobile device. That is, if a consumer associated with a mobile device purchases a new pair of shoes, a used vehicles, and a three dinners in a predetermined time period, such as a week or a month, the purchase behavior information may indicate each of the items, the amount spent on each item, the dates and/or times of day associated with each purchase, and/or aggregates of each or all of the purchases. In this way, purchasing behavior profiles, groups, labels, levels, etc., may be designated for the users 102 such that, appropriate promotions, games, and/or challenges may be targeted towards these users 102.

In some aspects, the client application interface 106 may provide a list of merchants determined to be within a predetermined distance of the mobile device 104 or related to (or associated with) a particular demographic or purchasing behavior, such as Merchants 1, 2, . . . , M. For example, the Merchants 1-M may be merchants determined to be within one mile, or some other distance, of the mobile device 104 or they may be merchants associated with games selected by the user 102. In other examples, however, Merchants 1-M may be merchants that match the user's 102 demographic and/or purchase behavior. For example, if a purchase behavior of a particular user 102 indicates that they purchase new shoes often, the Merchants 1-M may be shoe-store merchants when the mobile device 104 is near a shoe merchant or independent of the location of the mobile device. Similarly, if the user's purchase behavior also indicates that the user 102 eats lunch around noon every day, Merchants 1-M may be restaurants during or right before noon and shoe-store merchants at other times of the day. As desired, other combinations of purchasing behavior information may be used to determine what list of Merchants 1-M to be displayed at the client application interface 106.

Alternatively, or in addition, the client application interface 106 may provide a list of available games and/or challenges associated with merchants within a predetermined distance of the mobile device 104 and/or associated with information about the user 102 (such as demographic information and/or purchase history) of the computing device 104, such as Games 1, 2, . . . , X. For example, the Games 1-X may be games available, or provided by, merchants within the predetermined distance, or they may be games associated with, or otherwise provided by, merchants selected by the user 102 regardless of location. Further, Games 1-X may be associated with or otherwise related to merchants that match the user's 102 demographic information or profile and/or purchasing behavior information or profile. Additionally, once a user 102 has selected a promotion or correctly completed and/or answered a game and/or challenge, the client application interface 106 may be configured to display a promotional code 128.

As noted above, in some aspects, promotions, games, and/or challenges transmitted to the mobile devices 104 may be provided by the merchant computers 112 and/or the third-party computers 116. In one example embodiment, a first merchant computer, for example Merchant 1, may be a computing device controlled by a restaurant owner, manager, or employee and may transmit a game or challenge, for example Game 1, to the service provider computers 110. Similarly, Merchant 2, possibly a different restaurant, may provide and/or transmit a different game, for example, Game 3, to the service provider. In this example, the respective games and/or challenges may be 1) a request for a user 102 to learn the first restaurant manager's name and 2) a request for a user 102 to learn the fifth wine on the wine list of the second restaurant. In some aspects of this example, the user 102 may select the first game based on personal preference even if it is not geographically close to the user 102. The user 102 may then go to the first restaurant, ask for the manager's name, and enter the answer, or select from a list (e.g., in a multiple-choice question format), into the client application interface 106. An event outcome indicator may then be transmitted to the service provider computers 110 indicating that the user 102 is attempting to complete the challenge. Alternatively, the answer, and thus, the event outcome indicator, could be entered via a Web interface.

Upon transmitting the event outcome indicator to the service provider computer, the mobile device 104 may also transmit location information. In some aspects, the service provider computers 110 may validate the answer in the event outcome indicator by comparing it to the answer provided by the merchant computer 112. The service provider computers 110 may also, optionally, verify that the user 102 is actually at the location of the first restaurant if that is part of the challenge provided by the merchant computer 112. Alternatively, however, the validation and/or storage of the answer may take place on the mobile device 102 without any transmission to the service provider computers 110, for example in instances when there are bandwidth and/or connectivity issues or, optionally, it is not required by the provider of the promotion. In some examples, the service provider computers 110 may also verify that the user 102 is a registered user, that the game and/or challenge is still a valid game and/or challenge, and/or that the game and/or challenge was appropriately “unlocked” by the user 102 prior to completion.

In some aspects, once the service provider computers 110 determine that the event outcome indicator indicates a completed challenge, and other validations/verifications are complete, the promotional code 128 may be transmitted to the mobile device 104. The promotional code 128 may, in some instances, be unique for each transaction, game, challenge, user 102, and/or merchant. The promotional code 128 may then be presented to the merchant at the physical location, whereby the merchant or consumer performs one of the following to transmit promotional code 128 to the merchant computer 112 or POS device 114: card scan or swipe, barcode scan from the mobile device display, keypad entry, touch screen for input, mouse input, the transmission of a signal from the mobile device via NFC, or capturing other biometric input from the consumer such as fingerprint, voice, eye, or facial features. The promotional code 128 may then be transmitted from the POS device 114 or the merchant computer 112 to the service provider computers 110, and validated by the service provider computers 110. If validated, the service provider computers 110 may then indicate that the merchant should provide the associated promotion to the user 102, for example, because the user 102 has won the game and/or completed the challenge. Once completed, the next game and/or challenge may be “unlocked” for the user 104. In some instances, the discounts and/or promotions may become increasingly valuable as the user 102 “unlocks” additional games and/or challenges.

In another example embodiment, promotions, games, and/or promotions may be provided by third-party vendors or merchants, controlling third-party computers 116. For example, a third-party vendor may include a seller of a product that is sold at a merchant's store. In this embodiment, a third-party vendor may provide a game that requests a user 102 to complete one or more challenges related to the merchant store where the third-party vendor's product is sold or related to the third-party product. In one example, the third-party vendor may be a soda vendor and the game and/or challenge may be to purchase the third-party vendor's soda at a certain number of participating merchant stores. As such, the event outcome indicator may indicate to the service provider computers 110 that the user 102 has purchased the third-party vendor's soda at three participating stores. If this completes the challenge, the promotional code 128 may be provided to the mobile device 104 and the user 102 may be able to redeem for a promotion related to either one of the participating stores, another merchant, or the third-party vendor.

In some aspects, one or more servers, perhaps arranged in a cluster or as a server farm, may host the service provider. Other server architectures may also be used to host the service provider. The service provider computers 110 are capable of handling requests from many users 102 and serving, in response, various games, challenges, promotions, unique identifiers, and/or user interfaces that can be rendered at user computing devices 104(1)-(N).

In one illustrative configuration, the service provider computers 110 comprise at least a memory 130 and one or more processing units (or processor(s)) 132. The processor(s) 132 may be implemented as appropriate in hardware, software, firmware, or combinations thereof. Software or firmware implementations of the processor(s) 132 may include computer-executable or machine-executable instructions written in any suitable programming language to perform the various functions described.

The memory 130 may store program instructions that are loadable and executable on the processor(s) 132, as well as data generated during the execution of these programs. Depending on the configuration and type of service provider computers 110, the memory 130 may be volatile (such as random access memory (RAM)) and/or non-volatile (such as read-only memory (ROM), flash memory, etc.). The service provider computers 110 or server may also include additional storage 134 (e.g., removable and/or non-removable storage) including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 130 may include multiple different types of memory, such as static random access memory (SRAM), dynamic random access memory (DRAM), or ROM.

The memory 130, the removable and/or non-removable storage 134 are all examples of computer-readable storage media. For example, computer-readable storage media may include volatile and non-volatile, removable and non-removable media implemented in any method or technology for storage of information such as computer-readable instructions, data structures, program modules or other data. The memory 130 as well as the removable and/or non-removable storage 134 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the service provider computers 110 or other computing device. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The service provider computers 110 may also contain communications connection(s) 137 that allow the service provider computers 110 to communicate with a stored database, another computing device or server, user terminals, and/or other devices on a network. The service provider computers 110 may also include input/output (I/O) device(s) 138 such as a keyboard, a mouse, a pen, a voice input device, a touch input device, a display, speakers, a printer, etc.

Turning to the contents of the memory 130 in more detail, the memory 130 may include an operating system 142 and one or more application programs or services for implementing the features disclosed herein including a gaming module 144 and a promotions module 146, as well as one or more promotional codes 150 and/or promotional information 152. The gaming module 144 may be configured to receive, store, create, and/or determine outcomes of games and/or challenges provided by merchant computers 112. Additionally, the promotions module 146 may be configured to receive, store, create, determine, and/or manage promotions of the merchants and/or third party vendors.

In some aspects, the gaming module 144 may also be configured to select promotions, games, and/or challenges for presentation or transmittal to the mobile devices 104. In certain examples, the selection may be based at least in part on user information such as, but not limited to, a location of the mobile device 104, a location of a merchant or merchant computer 112, demographic information (e.g., age, address, salary range, etc.), enhanced demographic information (e.g., including additional information provided by the user 102 or gathered by a third-party, such as using third-party computer 116), and/or purchase behavior of the user 102. In some examples, the gaming module 144 may also be configured to determine a promotion, or list of promotions, to be transmitted to the a user device 104. Similarly, a list of merchants and/or games/challenges may be selected based on the user information.

By way of example only, a user 102 may have recently purchased a certain number, say four or five, products in the last month. As such, the purchasing history information may indicate that this user 102 has spent a certain amount of money on a first type of product (e.g., clothing) and a certain amount of money on a second type of product (e.g., computing devices). In this example, the gaming module 144 may then determine that the second type of product cost more money and select a promotion, a game, and/or a challenge associated with or related to computing devices. Additionally, the gaming module 144 may use the location information 124 to aid in the selection. That is, promotions, games, and/or challenges related to computing devices that are closer to, or within a predefined distance from, the mobile device 104 may be selected. The promotions, games, and/or challenges may then be transmitted to the mobile device 104.

In some examples, the memory 130 may also be configured to maintain, or otherwise store, promotional codes 150 that may be used for validating and/or verifying redemption of a promotion and/or promotional information 152 that may be used to map promotional codes 150 to additional information associated with promotions such as, but not limited to, devices, users, amount of discounts, and whether the discounts are for individual items and/or purchase totals. Additionally, the memory 130 may also be configured to maintain, or otherwise store, user information such as, but not limited to, the location of the mobile device 104, the location of a merchant or merchant computer 112, demographic information (e.g., age, address, salary range, etc.), enhanced demographic information (e.g., including additional information provided by the user 102 or gathered by a third-party, such as using third-party computer 116), and/or purchase behavior of the user 102.

In some aspects, one or more servers, perhaps arranged in a cluster or as a server farm, may host the merchant computers 112 and/or the transaction devices 114. Other server architectures may also be used to host the merchant computers 112 and/or the transaction devices 114. The merchant computers 112 and/or the transaction devices 114 are capable of handling requests from many users 102 and/or mobile devices 104 serving, in response, various interfaces for displaying item and/or total purchase prices as well as discounts and/or payment options. For example, upon a user 102 attempting to check-out of a store (e.g., where a merchant computer 112 is located), a transaction device 114 (such as, but not limited to, a POS device) may display the total cost of the transaction. Upon presenting a coupon or promotional code 128, via the mobile device 104 of the user 102, the transaction device 114 may look up, either locally or by querying the service provider computers 110, a discount to be applied. In some examples, the discount may be for a single item or for the total. Additionally, the discount may be a dollar value or a percentage. The transaction device 114 may then deduct the discount from the price of an item or from the total, and present the discounted price to the user 102. The mobile device 104 may then provide payment to the transaction device 114 to consummate the transaction.

In one illustrative configuration, the transaction devices 114 may comprise at least a memory 154 and one or more processing units (or processor(s)) 156. The processor(s) 156 may be implemented as appropriate in hardware, software, firmware, or combinations thereof. Software or firmware implementations of the processor(s) 156 may include computer-executable or machine-executable instructions written in any suitable programming language to perform the various functions described. Additionally, in some examples one or more merchant computers 112 may act a server for hosting the content displayed by the transaction devices 114. In this way, data processing and storage may take place at the merchant computers 112 on behalf of the transaction devices 114. As such, each of the modules, programs, data, etc. described with reference to the transaction devices 114 herein may also, or alternatively, be implemented by the merchant computers 112.

The memory 154 may store program instructions that are loadable and executable on the processor(s) 156, as well as data generated during the execution of these programs. Depending on the configuration and type of transaction devices 114, the memory 130 may be volatile (such as random access memory (RAM)) and/or non-volatile (such as read-only memory (ROM), flash memory, etc.). The transaction devices 114 may also include additional storage 158 (e.g., removable and/or non-removable storage) including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 154 may include multiple different types of memory, such as static random access memory (SRAM), dynamic random access memory (DRAM), or ROM.

The memory 154, the removable and/or non-removable storage 158 are all examples of computer-readable storage media. For example, computer-readable storage media may include volatile and non-volatile, removable and non-removable media implemented in any method or technology for storage of information such as computer-readable instructions, data structures, program modules or other data. The memory 154 as well as the removable and/or non-removable storage 158 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the transaction devices 114 or other computing device. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The transaction devices 114 may also contain communications connection(s) 160 that allow the transaction devices 114 to communicate with a stored database, another computing device or server, user terminals, and/or other devices on a network. The transaction devices 114 may also include input/output (I/O) device(s) 162 such as a keyboard, a mouse, a pen, a voice input device, a touch input device, a display, speakers, a printer, etc.

Turning to the contents of the memory 154 in more detail, the memory 154 may include an operating system 164 and one or more application programs or services for implementing the features disclosed herein including a redemption module 166 and a transaction module 168, as well as one or more promotional codes 170 and/or promotional information 172. The redemption module 166 may be configured to receive, store, and/or determine whether a user 102 is authorized to redeem a promotion based at least in part on a promotional code 128 provided by the mobile devices 104. Additionally, the redemption module 166 may be configured to determine the appropriate discount, if any, to be applied to a transaction. Additionally, the transaction module 168 may be configured to process transactions. For example, the transaction module 168 may provide the transaction values to the customers 102, deduct any discounts from the transaction values, and receive payment from the mobile devices 104, a bank, or other financial institution.

In some examples, the memory 154 may also be configured to maintain, or otherwise store, promotional codes 170 that may be used for validating and/or verifying redemption of a promotion and/or promotional information 172 that may be used to map promotional codes 170 to additional information associated with promotions such as, but not limited to, devices, users, amount of discounts, and whether the discounts are for individual items and/or purchase totals. In this example, the promotional codes 170 and/or promotional information 172 may be stored locally at the transaction devices 114 as opposed to, or in conjunction with, being stored at the service provider computers 110.

In at least one non-limiting example, a user 102 may receive a promotional code 128 from the service provider computers 110, the merchant computers 112, and/or the third-party computers 116 indicating that a promotional reward is available for use. In this example, the user 102 may select goods and/or services to purchase from a merchant and proceed to complete a transaction for the selected goods and/or services via a transaction device 114 of the merchant. The user 102 may then select a mobile payment method of the user's 102 mobile device 104 by activating the wallet module 125. Alternatively, or in addition, the wallet module 125 may be set in a default mode wherein the mobile payment method is pre-set. Additionally, the user 102 may select promotional rewards to redeem or use default rules (i.e., “reward rules”).

The mobile device (e.g., via the wallet module 125) may then effect the promotional rewards and make payment to the transaction device (e.g., a POS device) 114 in a seamlessly single transactional event. Alternatively, the user 102 may select the mobile payment method form the wallet module 125 and, upon performing a GPS check-in to the service provider computers 110, determine promotional reward eligibility locally or receive promotional reward eligibility from the service provider computers 110. In some examples, as noted above, the promotional information may be stored at the service provider computers 110, at the merchant computers 112 (e.g., in the server to one or more POS devices scenario), and/or at individual transaction devices 114. For example, the service provider computers 110 may periodically update the merchant computers 112 and/or the merchant computers 112 with promotional codes 128 and/or promotional information. As such, the promotional code 128 provided by the mobile device 104 may be verified, validated, or otherwise checked by querying the service provider computers 110 (e.g., promotional codes 150 and/or promotional information 152), the merchant computers 112, and/or the transaction device 114 processing the transaction (e.g., promotional codes 170 and/or promotional information 172).

The promotional reward may then either be applied at an item/service level or a total sales level. Again, the transaction may then be processed by the transaction device 114 in a single transaction. As such, the transaction device 114 may send a request to a payment processor identified by the wallet module 125 of the mobile device 104 and then receive payment from the payment processor. The checkout receipt from the transaction device 114 may reflect the item/services purchased, any rewards applied, the total sale, and/or payment information. Similarly, the user 102 may make a total purchase (e.g., promotional discount off of services) in a single transaction that does not utilize item level information. Further, the redeemed promotional rewards may be updated in the promotional information 152 of the service provider computers 110, the wallet module 125 of the mobile device 104, and/or the promotional information 172 of the transaction devices 114.

Further, as noted briefly above, in some instances, one or more transaction devices 114 may be configured in a distributed computing or server environment. In this example, a merchant computer 112 may act as the server and/or controller of the transaction devices 114. As such, upon receiving a promotional code 128 provided by a mobile device 104, the transaction device 114 may query the controller for validation and/or for promotional information associated with the promotional code 128. Additionally, in some examples, a payment processor may store and/or manage the promotional codes and/or promotional information. In this example, upon receipt of a promotional code 128 from a mobile device 104, the transaction device 114 and/or it's associated merchant computers 112 may query the payment processor for validation and/or for promotional information associated with the promotional code 128.

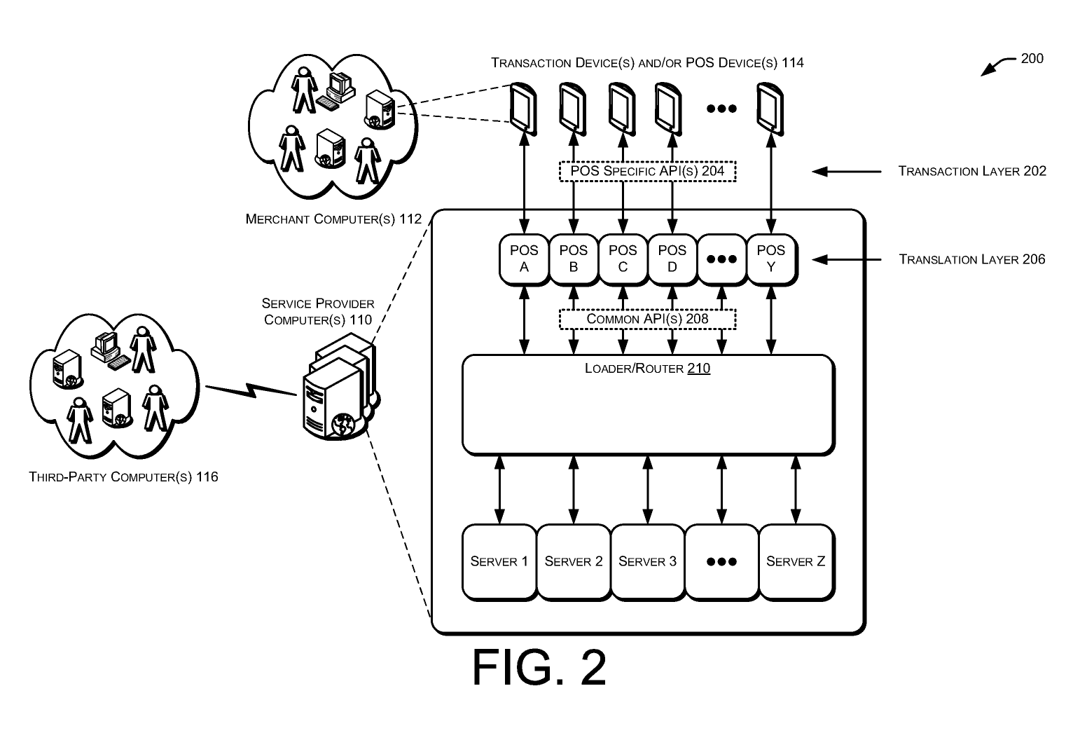

FIG. 2 depicts an illustrative architecture 200 in which additional techniques for providing games, challenges, and/or promotions to mobile devices may be implemented. In architecture 200, the service provider computer 110 is again shown in communication with merchant computers 112 and/or third-party computers 116 via one or more networks such as networks 108. Similarly, in some instances, the merchant computers 112 may be communicatively coupled to one or more transaction devices (hereinafter, “POS devices”) 114 for processing purchase transactions with the users 102. POS devices 114 may also be configured to communicate directly with the service provider computers 110 to facilitate the providing, managing, and/or processing of the games, challenges, and/or promotions.

In one embodiment, the service provider computer 110 may expose, or otherwise provide, an application programming interface (API) or multiple APIs for communicating with the POS devices 114, the merchant computers 112, and/or the third-party computers 116. More specifically, at a transaction layer 202, the service provider computers 110 may provide POS specific APIs 204 to each, or some, of the POS devices 114 associated with each, or some, of the merchant computers 112. For example, a first merchant may utilize a different type of POS device 114 than a second merchant (e.g., the different POS devices 114 may be made by different manufacturers, using different standards, and/or operating with different operating systems or with different architectures). In this example, the transaction layer 202 is configured to handle each transaction between the POS devices 114 and the service provider computers 110.

In any event, each POS device 114 may communicate with the service provider computers 110 using different POS specific APIs 204. As such, at a translation layer 206, each POS specific API 204 may be converted (or translated) into a common API 208 for communication with the loader/router 210 of the service provider computers 110. In some aspects, the loader/router 210 may be configured to recognize each POS device communication, for example shown as POS A, B, C, D, . . . , Y, appropriately translate each POS specific API 204 to the common API 208, and further route the common API instructions to the appropriate server, for example, Servers 1, 2, 3, . . . , Z.

Instructions, data, unique IDs 128, games, challenges, promotions, and/or any other information to be transmitted to the POS devices 114, mobile devices 104, merchant computers 112, and/or third-party computers 116 may then be sent from the appropriate server 1-Z to the loader/router 210. Based on the common APIs 208, this information may then be sent back to the translation layer 206 for translation back to the POS specific API 204 instructions. Alternatively, or in addition, third party computers 116, POS devices 114, and/or merchant computers 112 may communicate directly with the service provider computers 110 using a standard API. For example, in some instances, the translation layer 206 the load balancer, as well as the POS specific APIs 204 may not be utilized, and the POS devices 114 may be directly coupled to a server or other computing device of the service provider computers 110 or the merchant computers 112.

In architecture 200, the service provider computer 110 is again shown in communication with merchant computers 112 and/or third-party computers 116 via one or more networks such as networks 108. Similarly, in some instances, the merchant computers 112 may be communicatively coupled to one or more POS devices 114 for processing purchase transactions with the users 102. POS devices 114 may also be configured to communicate directly with the service provider computers 110 to facilitate the providing, managing, and/or processing of the games, challenges, and/or promotions

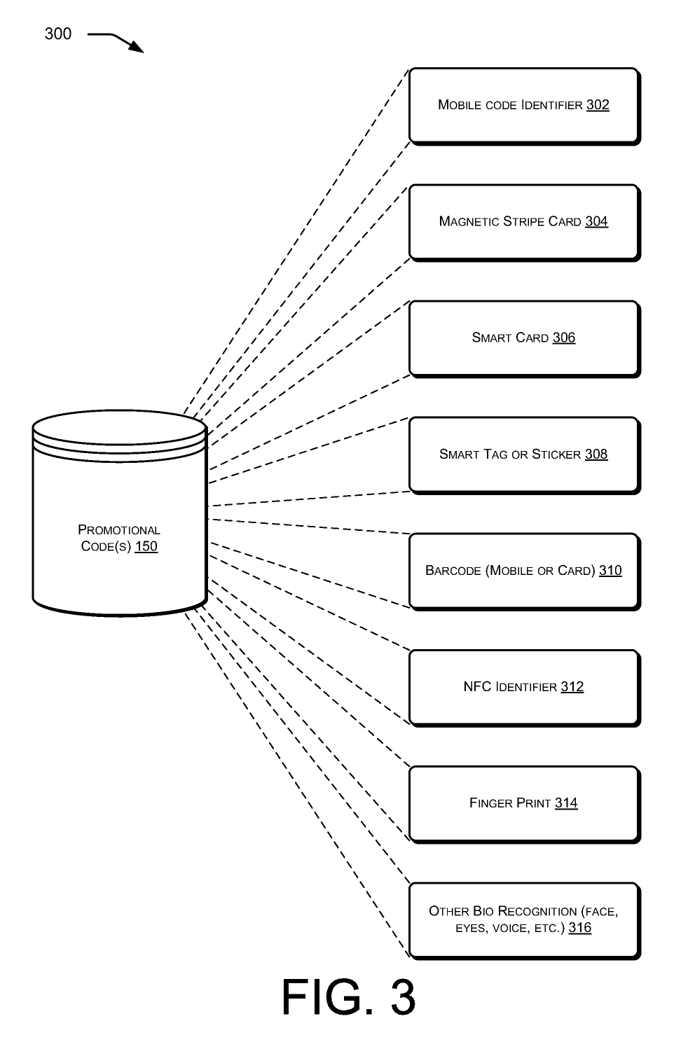

FIG. 3 depicts an illustrative promotional code datastore 150 in which additional techniques for providing integrated payment and reward transactions associated with a merchant and a transaction device may be implemented. As shown in FIG. 3, several different types of promotional codes may be stored, managed, and/or provided by the promotional code datastore 150. By way of example only, types of promotional codes may include mobile code identifiers 302, magnetic stripe cards 304, smart cards 306, and/or smart tags or stickers 308. Additionally, other types of promotional codes may include barcodes (either mobile barcodes or card barcodes) 310, NFC identifiers 312, finger print identifiers 314, and/or other bio-recognition identifiers 316, such as but not limited to face-recognition, eye-recognition, voice-recognition, etc.

In some examples, and when appropriate, the promotional code may be provided by the mobile device 104 of the user 102 to be presented to the merchant. For example, a mobile code identifier 302, a smart tag or sticker 308, a mobile barcode 310, and/or an NFC identifier 312, among others, may be easily transmitted to, and stored thereon, the appropriate mobile device 104. In other examples, however, the promotional code may be presented by the user 102 in ways other than electronically via the mobile device 104. However, the promotional code itself may be stored in a promotional code datastore 150. Further, the promotional code datastore 150 may be located in the memory 130 of the service provider computers 110, the memory 120 of a mobile device 104, the memory of the merchant computers 112, the memory 154 of the one or more POS devices 114, and/or the memory of the third-party computers 116.

Various instructions, methods and techniques described herein may be considered in the general context of computer-executable instructions, such as program modules, executed by one or more computers or other devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

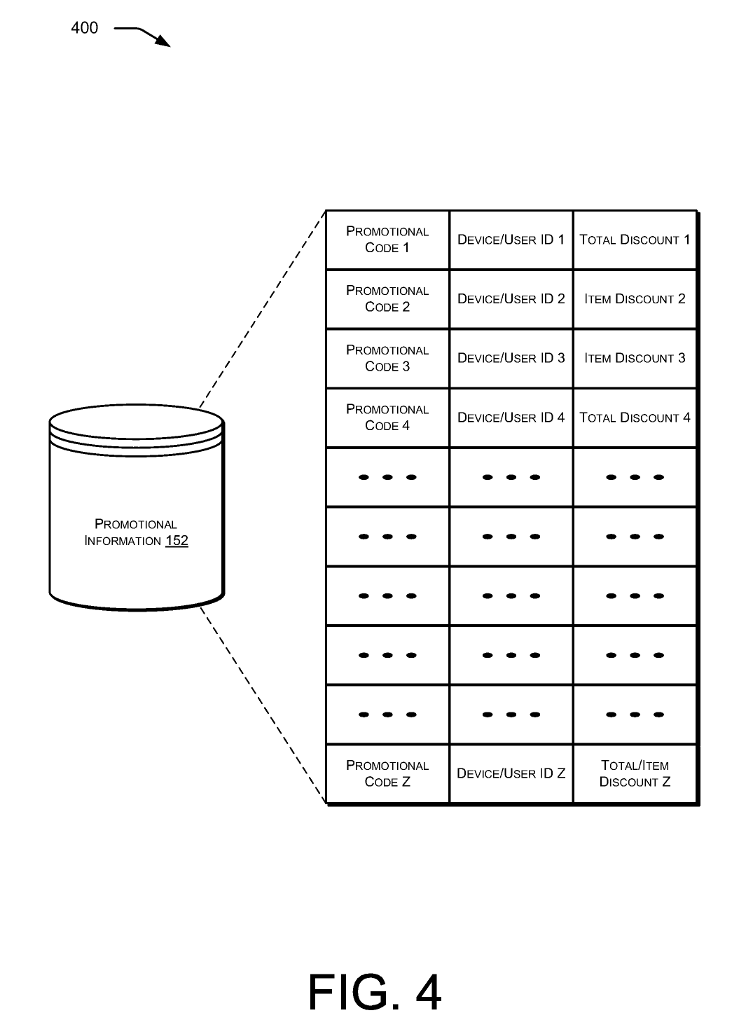

FIG. 4 depicts an illustrative promotional information datastore 152 in which additional techniques for providing integrated payment and reward transactions associated with a merchant and a transaction device may be implemented. As shown in FIG. 4, several different types of user information may be stored, managed, and/or provided by the promotional information datastore 152. By way of example only, types of user information may include the promotional codes 128, device and/or user identifiers, as well as item and/or total discounts. In some examples, the item and/or total discounts may inform the POS device 114 of the value of a discount and/or whether the discount is still valid and/or available. For example, once a discount has been redeemed, the value may be become zero.

In some examples, the promotional information datastore 152 may include a table, a chart, a graph, or other data structure for associating promotional codes with the appropriate user and/or device as well as with the appropriate discount value. By way of example only, a first column of the promotional information datastore 152 may include a list of promotional codes (e.g., Promotional Code 1, Promotional Code 2, . . . , Promotional Code Z). The second column may associate appropriate users 102 and/or mobile devices 104 with each promotional code. As such, in one example, when a POS device 114 queries the service provider computers, the merchant computers, the mobile device memory 120, and/or a payment processor based on a request from a particular user 102 and/or mobile device 104, the promotional information datastore 152 may validate the promotional reward by returning an identifier of that particular user 102 and/or the mobile device 104. Alternatively, if a different user 102 and/or mobile device 104 (i.e., not the user 102 and/or mobile device 104 attempting to redeem the promotion) is listed in the promotional information datastore 152 for a particular promotional code 128, the redemption may be denied. Further, in some examples, a third column may indicate an item and/or total discount associated with each promotional code.

Various instructions, methods and techniques described herein may be considered in the general context of computer-executable instructions, such as program modules, executed by one or more computers or other devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example architectures and computing devices shown in FIGS. 1-4 are provided by way of example only. Numerous other operating environments, system architectures, and device configurations are possible. Accordingly, embodiments of the present disclosure should not be construed as being limited to any particular operating environment, system architecture, or device configuration.

### Illustrative Processes

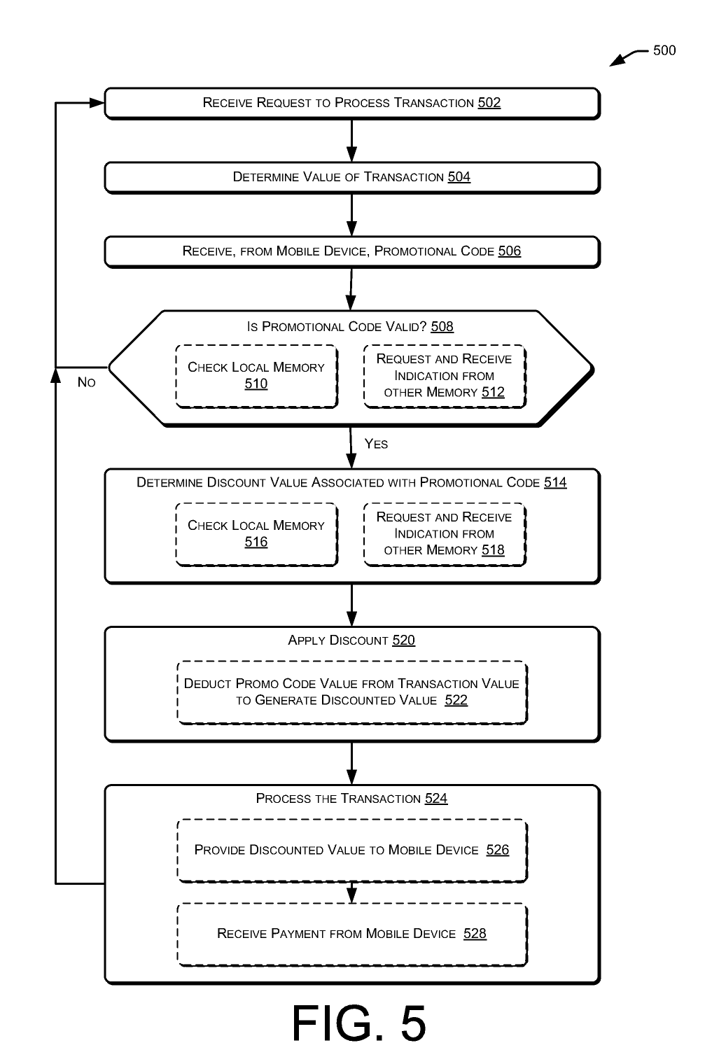

FIG. 5 is a flow diagram showing process 500 for providing integrated payment and reward transactions associated with a merchant and a transaction device. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

The process 500 may begin by receiving a request to process a transaction at 502. In one aspect, the request may be provided by a mobile device 104 on behalf of a user 102 who is attempting to purchase a good and/or service from a merchant. Additionally, in some examples, the request may be received by a transaction device such as, but not limited to POS device 114, associated with the merchant computers 112 of FIG. 1. At 504, the process 500 may determine a value of the transaction. In some examples, the transaction value may be the total price being charged for the goods and/or services that the user 102 is attempting to purchase at 502. The process 500 may then receive a promotional code associated with a reward, a coupon, or a discount at 506. In some examples, the promotional code may be received by a mobile device such as, but not limited to, the mobile device 104 and stored in the memory 154 associated with the POS device 114 of FIG. 1.

At 508, the process 500 may then determine whether the received promotional code is valid. For example, the promotional code may be valid if it has been earned by a user 102 (e.g., an outcome indicator indicates that a user has completed or won a game and/or challenge), if it has not yet been redeemed, and/or whether the redemption request is associated with a merchant that honors the particular or similar promotions. In some examples, determining whether the promotional code is valid may involve checking local memory at 510. In other examples, determining whether the promotional code is valid may involve requesting and receiving, in response to the request, an indication of validity from other (e.g., non-local) memory such as, but not limited to, the memory of the merchant computers 112, transaction devices 114, and/or a payment processor. If it is determined at 508 that the promotional code is invalid, the process 500 may return to 502 to receive (and/or wait to receive) additional requests to process transactions. Alternatively, if the process 500 determines that the promotional code is valid at 508, the process may then determine a discount value associated with the promotional code at 514.

In some examples, determining the discount value associated with the promotional code at 514 may include querying the promotional information 170 stored in the memory 154 of the transaction device 114 at 516 and/or querying the promotional information 152 stored in the memory 130 of the service provider computers 110 (or of the merchant computers 112 or a payment processor) at 518. At 520, the process 500 may apply the discount to the transaction value determined at 504. In some examples, applying the discount at 520 may include deduction the promotional code value determined at 514 from the transaction value determined at 504 to generate a discounted value at 522. In this way, the user 102 may be charged the discounted value. As noted above, the discount may be applied at an item/service level or a total value level. As such, the process 500 may deduct one or more promotional code values to one or more individual items and then generate a total discounted value or it may generate a total value and deduct a total discount to generate a total discounted value.

The process 500 may then process the transaction at 524. In some aspects, processing the transaction may include providing the discounted value to the mobile device 104 at 526 and then receiving payment from the mobile device at 528. Alternatively, in some examples, process the transaction at 524 may include providing the discounted value to the mobile device 104, receiving payment information associated with a payment processor, sending the discounted value to the identified payment processor, and receiving payment from the payment processor. As desired, other examples of processing the transaction may be utilized as well. The process 500 may then end by returning to 502, to receive (and/or wait to receive) additional requests to process transactions.

Illustrative methods and systems for providing games, challenges, and/or promotions to mobile devices are described above. Some or all of these systems and methods may, but need not, be implemented at least partially by architectures such as those shown in FIGS. 1-5 above.

### CONCLUSION

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A system, comprising:
at least one memory that stores computer-executable instructions;
at least one processor configured to access the at least one memory, wherein the at least one processor is configured to execute the computer-executable instructions to:
receive a request to process a transaction;
determine a value of the transaction;
receive, from a mobile device, a promotional code for a reward of a consumer, the promotional code being received by the mobile device, from a service provider, based at least in part on an event outcome indicator;
determine that the promotional code is valid;
determine a value associated with the promotional code;
apply a discount to the value of the transaction, the discount being based at least in part on the value associated with the promotional code; and
process the transaction based at least in part on the applied discount.

2. The system of claim 1, wherein the event outcome indicator comprises an indication that the mobile device has at least one of received an award as a result of a game, correctly answered a question, or completed a predefined task.

3. The system of claim 2, wherein at least one of the game, the question, or the predefined task is received, by the mobile device, from a third-party, a merchant, or the service provider.

4. The system of claim 1, wherein the promotional code is received, from the mobile device, by near field communication (NFC), image capture, wireless communication, or cellular communication.

5. The system of claim 1, wherein the at least one processor is further configured to determine that the promotional code is valid by executing the computer-executable instructions to compare the received promotional code against a promotional code stored in the at least one memory.

6. The system of claim 5, wherein the at least one processor is further configured to determine the value associated with the promotional code by executing the computer-executable instructions to retrieve the value associated with the promotional code from the at least one memory.

7. The system of claim 1, wherein the at least one processor is further configured to determine that the promotional code is valid by executing the computer-executable instructions to:
provide the promotional code to the service provider; and
receive, from the service provider, a validity indication associated with the promotional code.

8. The system of claim 7, wherein the at least one processor is further configured to determine the value associated with the promotional code by executing the computer-executable instructions to retrieve the value associated with the promotional code from the service provider.

9. The system of claim 1, wherein the at least one processor is further configured to apply the discount by executing the computer-executable instructions to deduct the discount from the value of the transaction to generate a discounted value.

10. The system of claim 9, wherein the at least one processor is further configured to process the transaction by executing the computer-executable instructions to:
provide the discounted value to the mobile device; and
receive a payment, from the mobile device, based at least in part on the discounted value.

11. A method, comprising:
receiving a request to process a transaction;
receiving a promotional code for a reward, the promotional code being received by a mobile device, from a service provider, based at least in part on an event outcome indicator;
determining that the promotional code is valid;
determining a value associated with the promotional code;
applying a discount to a value of the transaction, the discount being based at least in part on the value associated with the promotional code; and
processing the transaction based at least in part on the applied discount.

12. The method of claim 11, wherein the promotional code is received, from the mobile device, by near field communication (NFC), image capture, wireless communication, or cellular communication.

13. The method of claim 11, wherein the promotional code is received, from the service provider, based at least in part on biometric input.

14. The method of claim 13, wherein the biometric input comprises an eye scan, facial recognition, or a fingerprint scan of a consumer associated with the mobile device.

15. The method of claim 11, wherein applying the discount comprises deducting the discount from the value of the transaction to generate a discounted value.

16. The method of claim 15, wherein processing the transaction comprises receiving payment, from the mobile device, based at least in part on the discounted value.

17. One or more computer-readable media storing computer-executable instructions that, when executed by at least one processor, configure the at least one processor to perform operations comprising:
receiving, from a mobile device, a promotional code;
determining a value associated with the promotional code;
applying a discount to a value of a transaction, the discount being based at least in part on the value associated with the promotional code; and
processing the transaction based at least in part on the applied discount.

18. The method of claim 17, wherein the promotional code is received, from the mobile device, by near field communication (NFC), image capture, wireless communication, or cellular communication.

19. The method of claim 17, wherein the promotional code is received, from the service provider, based at least in part on biometric input.

20. The one or more computer-readable media of claim 17, wherein processing the transaction comprises receiving payment from the mobile device.
